(19) United States
(12) Patent Application Publication
(10) Pub. No.: US 2023/0191492 A1
(43) Pub. Date: Jun. 22, 2023

(54) THREE-DIMENSIONAL OBJECT PHYSICAL PROPERTY DEVIATION DETERMINATION

(71) Applicant: Hewlett-Packard Development Company, L.P., Spring, TX (US)

(72) Inventors: William J Allen, Corvallis, OR (US); Temiloluwa Adegoke, Corvallis, OR (US); Matthew Gaubatz, Seattle, WA (US); John C Greeven, Corvallis, OR (US); Daniel Mosher, Corvallis, OR (US); Thomas A Saksa, Corvallis, OR (US); Vanessa Verzwyvelt, Vancouver, WA (US); Michael F Klopfenstein, Vancouver, WA (US); Xin Cheng, Vancouver, WA (US); Richard Sweet, San Diego, CA (US); Todd Hegert Goyen, Vancouver, WA (US)

(21) Appl. No.: 17/996,050

(22) PCT Filed: Apr. 29, 2020
(86) PCT No.: PCT/US2020/030341

§ 371 Date: Oct. 12, 2022

(51) Int. Cl. B22F 10/85; B33Y 50/02; B22F 10/38; B22F 10/32

(52) U.S. Cl. CPC B22F 10/85; B33Y 50/02; B22F 10/38; B22F 10/32; B33Y 10/00

(57) ABSTRACT

In some examples, a system receives measurement data obtained based on a non-destructive imaging of an identifiable structure within a three-dimensional (3D) object formed using an additive manufacturing machine, the identifiable structure formed based on control of a characteristic of a build material of a first internal object portion relative to a characteristic of the build material in a second internal object portion, the first and second internal object portions being within the 3D object. The system determines, based on the measurement data, a deviation of a physical property of the identifiable structure from a target physical property, and outputs information indicating the deviation.

### BACKGROUND

Additive manufacturing machines produce three-dimensional (3D) objects by accumulating layers of build material, including a layer-by-layer accumulation and solidification of the build material patterned from computer aided design (CAD) models or other digital representations of physical 3D objects to be formed. A type of an additive manufacturing machine is referred to as a 3D printing system. Each layer of the build material is patterned into a corresponding part (or parts) of the 3D object.

### BRIEF DESCRIPTION OF THE DRAWINGS

Some implementations of the present disclosure are described with respect to the following figures.

FIG. 1 is a block diagram of an arrangement that includes an additive manufacturing machine and a computer for analyzing deviations of physical properties of identifiable structures within 3D objects built by the additive manufacturing machine, in accordance with some examples.

FIG. 2 is a flow diagram of a process according to some examples.

FIG. 3 is a storage medium storing machine-readable instructions, according to some examples.

FIG. 4 is a block diagram of a system according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a build material used by an additive manufacturing machine such as a 3D printing system can include a powdered build material that is composed of particles in the form of fine powder or granules. The powdered build material can include metal particles, plastic particles, polymer particles, ceramic particles, glass particles, or particles of other powder-like materials. In some examples, a build material powder may be formed from, or may include, short fibers that may, for example, have been cut into short lengths from long strands or threads of material.

In other examples, non-powdered build materials can also be used by an additive manufacturing machine.

In some examples of additive manufacturing machines, as part of the processing of each layer of build material, liquid agents can be dispensed by liquid agent dispensers (such as through a printhead or another fluid dispensing device) into a layer of build material. In examples where the build material is a non-metallic build material such as plastic or polymer, then the applied liquid agents can include a fusing agent (which is a form of an energy absorbing agent) that absorbs heat energy emitted from an energy source used in the additive manufacturing process. For example, after a layer of build material is deposited onto a build platform (or onto a previously formed layer of build material) in the additive manufacturing machine, a fusing agent with a target pattern can be deposited on the layer of build material. The target pattern can be based on an object model (or more generally, a digital representation) of the physical 3D object that is to be built by the additive manufacturing machine.

According to some examples, a fusing agent may be a liquid formulation that when deposited into portions of a build material layer absorbs radiated energy, including infrared and visible light energy. For example, the fusing agent formulation can include the V1Q60A “HP fusing agent” available from HP Inc. In further examples, a fusing agent may alternatively or additionally include an infrared light absorber, a near infrared light absorber, a visible light absorber, or an ultraviolet (UV) light absorber. After application of the fusing agent into portions of a build material layer, fusing energy is applied to heat up the build material layer portions for melting. The melted build material layer portions are then coalesced, followed by solidification of the build material layer portions.

If a powdered metal build material is used, then an additive manufacturing machine can apply a binder agent to layers of powdered metal build material such that the binder agent is applied to selected portions of each layer. In some examples, the binder agent can include a liquid functional agent (LFA), which is a water-based binder agent that includes latex, solvents, and surfactants. Alternatively, the binder agent can include a pre-wetting liquid that can be applied to promote or inhibit infiltration of another binder agent. In addition, multiple types of binder agents can be used in some examples.

As each layer of the powdered metal build material is deposited, a binder agent can subsequently be dispensed by liquid agent dispensers (such as through a printhead or another fluid dispensing device) to the layer. Portions of the powdered metal build material where the binder agent is applied are bound together by the binder agent. The binder agent can include an ultraviolet-curable binder agent, heat-curable binder agent, and so forth. After the layers of powdered metal build material have been deposited and the binder agent has been applied to locations of each layer of the powdered metal build material, curing (e.g., based on application of heat or ultraviolet light in the additive manufacturing machine) of the binder agent in the layers of the powdered metal build material produces a so-called “green part.” The green part is de-powdered to remove any external unbound build material powder. Afterwards, the green part can be transferred to an oven, where the binder agent can be decomposed from a thermal process, and where the bound build material powder (e.g., metal particles, etc.) are sintered together to form a highly dense 3D object. Sintering refers to coalescing powdered particles to form a solid mass with a higher density than the green part. When sintering the green part in the oven, the entirety of the green part is subject to the same heating applied by the oven, as opposed to selective application of different local heat to different local volumes of the green part in the additive manufacturing machine. In some cases, layer-by-layer curing may also be performed, which results in uniform heating of each layer.

An “external surface” of a 3D object refers to the surface that is visible or that is touchable by a user.

In some cases, it may be desirable to selectively control a material property in inner regions of the 3D object, based on selective application of a binder agent during a build process of the 3D object. An “inner region” of a 3D object refers to a region of the 3D object that is inside the 3D object away from the external surface of the 3D object. In some cases, a part of an inner region of a 3D object may extend to the external surface of the 3D object, and thus be exposed.

In some examples, the material property that can be selectively controlled is a mechanical property of the material making up the 3D object. Examples of mechanical properties can include any or some combination of the following: density, modulus of elasticity, tensile strength, hardness, etc. In other examples, other types of material properties can be selectively controlled, such as an acoustical property, an optical property, a chemical property, and so forth. In some examples, the material property that is selectively controlled is not color.

The selective control of the material property of the inner regions of the 3D object can produce an identifiable structure formed inside the 3D object. Internal modulation of a material property of inner regions of the 3D object can be performed to form the identifiable structure within the 3D object.

The identifiable structure within the 3D object can be formed based on selective application of an agent (e.g., a fusing agent, a binder agent, a contrast enhancing material, etc.) to selected regions when forming layers of the 3D object. Examples of contrast enhancing materials are discussed further below. The selective application of an agent performs selective modulation of a material property of the selected regions, as compared to a material property of remaining regions of the 3D object. In examples where a fusing agent is used for forming a non-metallic 3D object, elements of the fusing agent (e.g., carbon black particles when a black fusing agent is used) may remain in the final 3D object that is built. In other examples where a binder agent is used for forming a metallic 3D object, very little or no remnant of the binder agent remains after the sintering phase.

In other examples, an additive manufacturing process can use non-powdered build materials. The non-powdered build materials can be controlled to provide different material properties within a 3D object based on use of different curing temperatures or curing times of different regions within the 3D object, or exposure of different regions within the 3D object to different environmental conditions to cause activation of different material properties, or using different combinations of materials (e.g., organic or synthetic materials) in different regions within the 3D object to achieve different material properties. Examples of additive manufacturing processes that use non-powdered build materials include fused deposition modeling processes and UV cured resin processes (e.g., stereo lithography). For example, a fused deposition modeling additive manufacturing technique can use a solid that is melted to a liquid and cooled back to a solid, and a UV cured resin additive manufacturing technique can use a liquid that is cured into a solid form upon application of radiated energy.

In some examples, a non-destructive imaging technique can be used to detect the identifiable structure. For example, the imaging technique can include a non-invasive X-ray imaging technique, a magnetic imaging technique, a computerized axial tomography (CAT) scan imaging technique, an acoustic detection technique, and so forth. A non-destructive imaging technique is able to detect an image of the identifiable structure within the 3D object. As an example, the identifiable structure can include a barcode, a QR code, or any other type of structure inside the 3D object. As another example, the identifiable structure can be composed of glyphs in two or more dimensions. As yet another example, the identifiable structure can have a predefined shape, or a collection of shapes. The shape(s) of the identifiable structure can be an inherent shape of the structure or can be chosen off-line or during production.

An example of an acoustic detection technique includes an ultrasound detection technique, such as a reflection time ultrasound detection technique. Another example of an ultrasound detection technique includes a scanning acoustic microscope (SAM) technique, which is based on use of an array of ultrasonic transmitters and ultrasonic receivers.

In other examples, other types of techniques can be used to detect the identifiable structure formed within the 3D object, such as by using an electrical-based detection technique, a magnetic-based detection technique, an electromagnetic-based detection technique, and so forth. An example of an electromagnetic-based detection technique uses a millimeter (mm) wave (mmW) mechanism. A mm wave refers to an electromagnetic signal in the 30 to 300 gigahertz (GHz) range, for example. In some examples, the mmW mechanism can include mmW antennas that emit and receive mm waves that are propagated into a 3D part under study. Reflected mm waves are studied to detect an identifiable structure in a 3D object.

An issue associated with building 3D object using an additive manufacturing machine is that the 3D object built by the additive manufacturing machine may have a physical property that deviates from a target physical property. A “target” physical property refers to a physical property of a portion of the 3D object (either a sub-part of the 3D object or an entirety of the 3D object) intended to be formed based on a digital representation of the 3D object used by the additive manufacturing machine to form the 3D object.

A “physical property” can refer to any or some combination of:
a geometric property of a portion of the 3D object, e.g., a shape, a dimension (e.g., a size, a length, a width, a height, etc.), a location, and/or any other geometric property;
a mechanical property of the 3D object portion, e.g., a density of the 3D object portion, a modulus of elasticity of the 3D object portion, a tensile strength of the 3D object portion, a hardness of the 3D object portion, a quality of the 3D object portion such as based on a measure of a manufacturing tolerance of the 3D object portion (whether a dimension or location of the 3D object portion is within a target dimension or location by within a specified threshold, etc.), and/or any other mechanical property;
an electrical property of the 3D object portion (e.g., a resistance or conductance, etc.);
an electromechancial property of the 3D object portion, where an electromechancial property refers to a combination of both electrical and mechanical properties;
an acoustical property of the 3D object portion;
an optical property of the 3D object portion;
a chemical property of the 3D object portion;
and so forth.

It is difficult to determine whether inner portions of a 3D object formed by an additive manufacturing machine meet target physical properties, without actually cutting apart of the 3D object and performing an invasive analysis of the 3D object, which is time-consuming, labor-intensive, and may damage or destroy the 3D object.

In accordance with some implementations of the present disclosure, techniques or mechanisms are provided that receive measurement data based on non-destructive imaging of an identifiable structure within a 3D object formed using an additive manufacturing machine, where the identifiable structure is formed based on control of a characteristic of a build material of a first internal object portion relative to a characteristic of the build material in a second internal object portion. Based on the measurement data, deviation of a physical property of the identifiable structure from a target physical property is determined, and information indicating the deviation can be output for use in controlling a build operation of the additive manufacturing machine or another additive manufacturing machine.

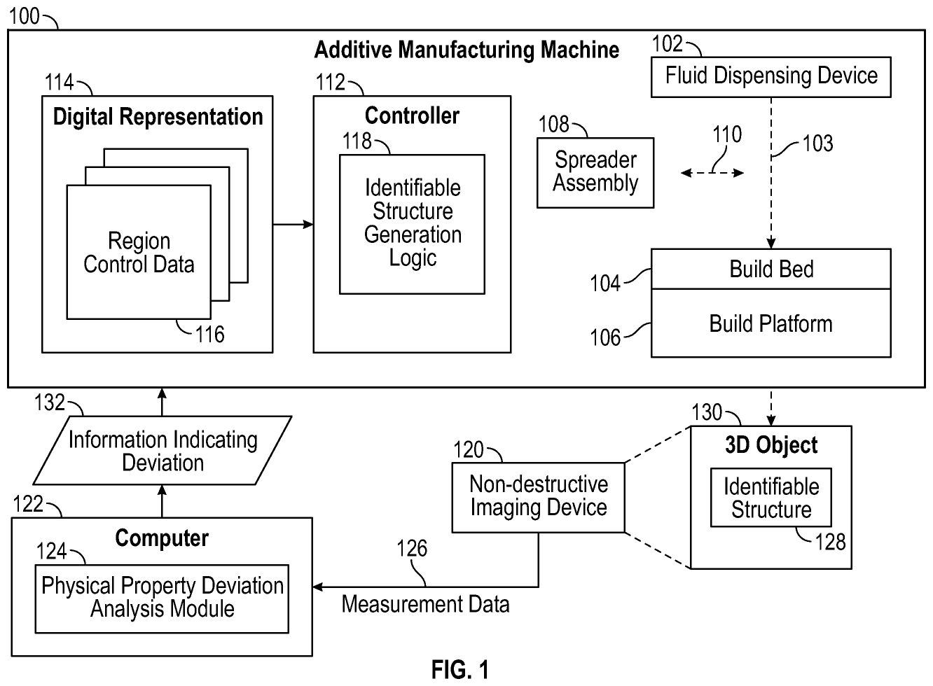

FIG. 1 is a block diagram of an example arrangement that includes a portion of an additive manufacturing machine 100, a non-destructive imaging device 120, and a computer 122 according to some examples. The computer 122 includes a physical property deviation analysis module 124, which can be implemented as machine-readable instructions executed by the computer 122, for example.

The physical property deviation analysis module 124 receives measurement data 126 from the non-destructive imaging device 120. The measurement data 126 is based on non-destructive imaging, by the non-destructive imaging device 120, of an identifiable structure 128 within a 3D object 130 formed using the additive manufacturing machine 100.

The non-destructive imaging performed by the non-destructive imaging device 120 can include any or some combination of the non-destructive imaging techniques discussed further above.

Although FIG. 1 shows one non-destructive imaging device 120, in other examples, multiple non-destructive imaging devices 120 can be used to produce measurement data based on non-destructive imaging of the identifiable structure 128 within the 3D object 130.

Although just one identifiable structure 128 is shown in FIG. 1, it is noted that the 3D object 130 can include multiple identifiable structures within the 3D object 130 that can be imaged by the non-destructive imaging device(s) 120.

The identifiable structure 128 is formed based on control of a characteristic of a build material of a first internal object portion (within the 3D object 130) relative to a characteristic of the build material in a second internal object portion (within the 3D object 130).

Based on the measurement data 126, the physical property deviation analysis module 124 determines a deviation of a physical property of the identifiable structure 128 from a target physical property. The physical property deviation analysis module 124 outputs information 132 indicating the deviation for use in controlling a build operation of the additive manufacturing machine 100 or another additive manufacturing machine.

The additive manufacturing machine 100 includes a fluid dispensing device 102 (e.g., a printhead), which is able to dispense fluid (such as generally in a downward direction 103 in the view shown in FIG. 1). The fluid dispensing device 102 includes nozzles to dispense a liquid agent to a layer of build material that is part of a build bed 104. In other examples, the additive manufacturing machine 100 can include multiple fluid dispensing devices 102.

Initially, before a 3D build operation has started, the build bed 104 includes the upper surface of a build platform 106. After build material layers have been spread over the build platform and processed on a layer-by-layer basis, the build bed 104 would include any previously formed part(s) of the 3D object based on the previously processed build material layer(s). More generally, a “build bed” refers to a structure onto which a build material layer can be spread for processing, where the structure can include just the upper surface of the build platform 106, or alternatively, can further include any previously formed part(s) of a 3D object.

In some examples, the fluid dispensing device 102 can be mounted to a moveable carriage (not shown) in the additive manufacturing machine 100. During a build process, the carriage can move back and forth to move the fluid dispensing device 102 along a scan axis, to dispense liquid agents to the layer of build material during a build operation. In other examples, the fluid dispensing device 102 can be moved along multiple different scan axes.

The additive manufacturing machine 100 also includes a spreader assembly 108 that is used to spread a powdered build material across the build bed 104. The spreader assembly 108 (including a roller, a blade, etc.) is moveable in a spread direction (along a spread axis 110) to spread the powdered build material from a supply of the powdered build material across the build bed 104. Note that the spreader assembly 108 can move in each of the two opposite directions along the spread axis 110 when spreading a powdered build material.

After a layer of powdered build material has been spread across the build bed 104 by the spreader assembly 108, the fluid dispensing device 102 is used to dispense a liquid agent to selected portions of the layer of powdered build material. If the powdered build material includes a polymer or plastic (or any other non-metallic material that may be melted based on application of a fusing energy to portions of the layer of powdered build material into which the liquid agent is dispensed), then the dispensed liquid agent can include a fusing agent. If the powdered build material includes a metal, then the dispensed liquid agent can include a binder agent.

In examples where the additive manufacturing machine 100 includes a selective laser melting (SLM) or selecting laser sintering (SLS) printer, then a laser-based fabrication technique is used that does not involve dispensing of liquid agents.

The additive manufacturing machine 100 includes a controller 112 that can be used to control an additive manufacturing process in the additive manufacturing machine 100 for building a 3D object, such as the 3D object 130. As used here, a “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

An additive manufacturing process includes the spreading of a layer of a powdered build material across the build bed 104 by the spreader assembly 108, and the dispensing of a liquid agent by the fluid dispensing device 102.

Although not shown, the additive manufacturing machine 100 further includes a heating assembly for applying heat during the additive manufacturing process. As examples, the heating assembly can include a heating lamp (or multiple heating lamps). In some examples, heat can be applied by the heating assembly to cause melting of portions of a powdered build material layer into which a fusing agent has been applied. The heat can cause melting of the portions of the powdered build material layer, which can then be coalesced and solidified.

In other examples where the build material layer includes metal, the heat applied by the heating assembly can cure a heat-curable binder agent during the additive manufacturing process. In other examples, if a UV-curable binder agent is used, then a UV light source assembly (not shown) can be activated to cure the UV-curable binder agent.

The controller 112 can control the operations of the spreader assembly 108, the fluid dispensing device 102, the heat assembly, and/or the UV light source assembly during the additive manufacturing process.

The controller 112 receives input data that includes a digital representation 114 of a 3D object to be built by the additive manufacturing machine 100. In some examples, the digital representation 114 of the 3D object can include a computer aided design (CAD) file (or multiple CAD files).

The digital representation 114 contains region control data 116 to define inner regions that are to be formed internally in the 3D object that is to be built by the additive manufacturing machine 100. An inner region formed based on the region control data 116 can refer to a volume in a 3D object that has a material property (e.g., a density or other material property) that is different from the material property of surrounding portions of the 3D object.

In some examples, the controller 112 can include identifiable structure generation logic 118 to control the formation of an identifiable structure (e.g., 128 in FIG. 1) in the 3D object that uses selective modulation of a material property in inner regions of the 3D object. The identifiable structure generation logic 118 can be implemented using a portion of the hardware processing circuit of the controller 112, or can be implemented using machine-readable instructions executable by the controller 112.

As noted above, in some examples, a selective modulation of the inner regions of the 3D object can be based on selective application of a liquid agent (e.g., a fusing agent, a binder agent, etc.) during an additive manufacturing process. In other examples, a selective modulation of the inner regions of the 3D object can be additionally or alternatively based on adding a contrast enhancing material (discussed further below) to define the inner regions with different material properties than other regions of a powdered build material layer. In further examples, a selective modulation of the inner regions of the 3D object may be based on selective application of energy, such as a directed laser beam, to produce regionally distinct material properties.

The selective application of an agent (e.g., a fusing agent, a binder agent, a contrast enhancing material, etc.) is controlled by the identifiable structure generation logic 118 according to the region control data 116 in the digital representation 114. The agent is selectively applied to portions of a layer of a powdered build material on the build bed 104 to form respective portions that have a different amount of the agent relative to other portions of the layer of powdered build material.

Examples of a contrast enhancing material can include any or some combination of the following: a metal containing compound; micro- and/or nano-particles of metals (e.g., micro- and/or nano-particles suspended in a liquid that is selectively applied), metal composites, and/or metal oxides; contrast media such as X-ray contrast media and magnetic resonance contrast media. X-ray contrast media; and so forth. The contrast enhancing material can be added by the fluid dispensing device 102, or alternatively, by a coating device or any other type of applicator that is able to apply a material to the build bed 104 at selected locations.

In alternative examples, the additive manufacturing machine 100 can use non-powdered build materials. To achieve internal modulation of regions within a 3D object, the non-powdered build materials can be controlled to provide different material properties within a 3D object based on use of different curing temperatures or curing times of different regions within the 3D object, or exposure of different regions within the 3D object to different environmental conditions to cause activation of different material properties, or using different combinations of materials (e.g., organic or synthetic materials) in different regions within the 3D object to achieve different material properties.

In some examples when a powdered metal build material and a binder agent are used, after sintering, a portion of the powdered metal build material that is without a binder agent or that has a reduced amount of a binder agent has a greater density (or more generally, a different material property) than another portion of the powdered metal build material that has a larger amount of the binder agent. To form a target portion with reduced density, the target portion can be oversaturated with the binder agent, such that the excess binder agent will remain on the surface of the target portion, and impede powder deposition onto another portion above the target portion. After binder burn-out (e.g., sintering in an oven), the excess binder agent will cause creation of a local lower density portion within the metal part.

Alternatively, to form a reduced density portion for a powdered non-metallic build material (e.g., a polymer or plastic build material), selective application of a fusing agent and/or a contrast enhancing material can be employed to define inner regions of different densities to form a corresponding identifiable structure within a 3D object.

FIG. 1 shows an example where the identifiable structure generation logic 118 is included as part of the additive manufacturing machine controller 112 that controls various components (e.g., the spreader assembly 108, the fluid dispensing device 102, the heating assembly, the UV light source assembly, etc.) during an additive manufacturing process.

In other examples, the identifiable structure generation logic 118 can be part of a different controller in the additive manufacturing machine 100, or can be part of a computer that is external to and separate from the additive manufacturing machine 100. In such latter examples, the separate controller or computer can generate print data that is used by the additive manufacturing machine controller 112 in building a 3D object that includes an identifiable structure (or multiple identifiable structures).

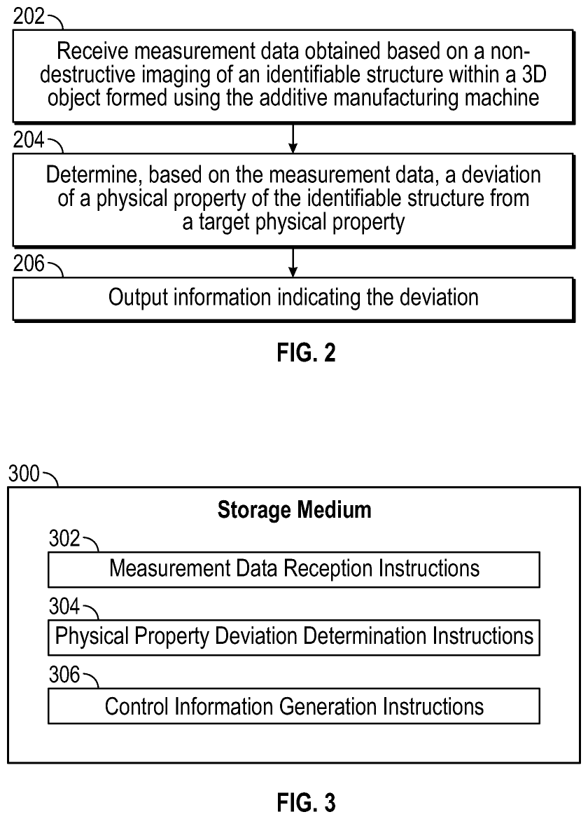

FIG. 2 is a flow diagram of a process that can be performed by the physical property deviation analysis module 124, for example.

The physical property deviation analysis module 124 receives (at 202) measurement data obtained based on a non-destructive imaging (such as by the non-destructive imaging device 120 of FIG. 1) of an identifiable structure within a 3D object formed using the additive manufacturing machine 100.

Examples of the non-destructive imaging include any or some combination of the following: a non-invasive X-ray imaging technique, a magnetic imaging technique, a CAT scan imaging technique, an acoustic detection technique, an electrical-based detection technique, a magnetic-based detection technique, an electromagnetic-based detection technique (e.g., by use of an mmW mechanism), and so forth.

The physical property deviation analysis module 124 determines (at 204), based on the measurement data, a deviation of a physical property (e.g., a geometric property, a mechanical property, an electrical property, an electromechancial property, an acoustical property, an optical property, a chemical property, etc.) of the identifiable structure from a target physical property.

As an example, to determine (at 204) the deviation, the physical property deviation analysis module 124 can align the measurement of the identifiable structure in a 3D object formed using the additive manufacturing machine 100 with a model of the identifiable structure. Examples of aligning the identifiable structure with the model of the identifiable structure can include regenerating a (3D) image of a barcode or sequence of glyphs based a combination of the measurement data 126 and/or the region control data 116, and registering the model of the identifiable structure with respect to the measured representation of the identifiable structure, to determine how the positions of elements in the model of the identifiable structure map to positions of elements in the measured representation of the identifiable structure. The registering above can use barcode finder patterns, pixel-based multi-resolution analysis, detection of scale-invariant features, iterative closest point methods, and the like.

For example, determining a deviation of a geometric property of the identifiable structure can include identifying a deformity of the identifiable structure from a target physical geometry of the identifiable structure. The target physical geometry of the identifiable structure includes a shape or dimension of the identifiable structure.

As a further example, determining a deviation of a geometric property of the identifiable structure can include identifying a deviation of a physical coordinate of the identifiable structure from a target physical coordinate within the 3D object.

As another example, determining a deviation of a mechanical property of the identifiable structure can include identifying a deviation of a quality of the identifiable structure from a target quality of the identifiable structure.

In other examples, deviations of other physical properties of the identifiable structure can be determined.

The physical property deviation analysis module 124 outputs (at 206) information indicating the deviation. The information indicating the deviation can include identifying a difference in value of the physical property of the identifiable structure in the 3D object and a value of the target physical property (e.g., a difference in coordinates, a difference in size or shape, etc.).

In some examples, the outputting of the information includes providing the information to a given additive manufacturing machine, which can be the additive manufacturing machine 100 or another additive manufacturing machine, to modify, based on the information, a build operation of the additive manufacturing machine 100 or another additive manufacturing machine when forming a 3D object. In such examples, the information indicating the deviation can include machine control information that the additive manufacturing machine 100 or another additive manufacturing machine can use to modify a build operation.

For example, in instances where the deviation analysis output reveals unexpected localized deviations in physical material behavior, such as volumetric changes to the layer in response to some additive joining operation, then updates to vicinity-based subsequent forming instructions (e.g., modifications to layer slice geometries or spatial agent jetting requirements) may be used to compensate for the deviations. When such deviations are consistent across the build area within a defined criterion, the process modification strategy in the build operation may involve modifications to non-delineated process parameters, such as platform drop distance or target temperature. In some situations, it may even be desirable to selectively insert supplementary forming operations (e.g., secondary compaction or layer curing) into the additive construction process; the property deviation analysis output may be used to determine when it becomes appropriate to add, remove, or modify such process steps.

The modification of the build operation based on the information indicating the deviation can include modifying a value of a parameter that controls a build task by the additive manufacturing machine or the another additive manufacturing machine in forming a 3D object. More generally, values of a collection of parameters can be modified to control a build task of a build operation. A “collection of parameters” can include just a single parameter or multiple parameters.

Examples of parameters that can be modified include any or a combination of: a temperature parameter that controls a temperature during the build operation, a speed parameter that controls a speed of the build operation, a timing parameter that controls a timing or duration of a build task of the build operation, a build material dimension parameter that controls a dimension (e.g., thickness or another dimension) of a build material layer, an agent parameter that controls a type or quantity of liquid agent used during the build operation, or any other type of parameter.

As further examples, the modification of the build operation based on the information indicating the deviation can include modifying a sequence or order of tasks of a build operation, such as by changing the order of existing build tasks, or by adding, removing, or modifying physical operations relating to building of a 3D object. For example, an additional treatment (such as application of an agent, a heat treatment, etc.) can be applied to one build material layer but not to another build material layer, to achieve localized control of build material layers that can vary across layers of a build operation for a 3D object.

FIG. 3 is a block diagram of a non-transitory machine-readable or computer-readable storage medium 300 storing machine-readable instructions that upon execution cause a system to perform various tasks.

The machine-readable instructions include measurement data reception instructions 302 to receive measurement data of an identifiable structure within a 3D object formed by an additive manufacturing machine according to a digital representation including information identifying first regions in the 3D object with a material property different from a material property of other regions in the 3D object, and the information for use by the additive manufacturing machine in controlling a first amount of an agent to be applied to a first portion of a build material that is different from a second amount of the agent to be applied to a second portion of the build material, wherein the second portion is contained within the first portion, where the identifiable structure includes the second portion, and where the identifiable structure includes the second portion.

In some examples, the first portion is a shell that fully or partially encloses the second portion.

The agent that can be selectively applied to the first and second portions in different amounts can include a fusing agent, a binder agent, a contrast enhancing material, or any other material.

The machine-readable instructions include physical property deviation determination instructions 304 to determine, based on the measurement data, a deviation of a physical property of the identifiable structure from a target physical property.

The machine-readable instructions include control information generation instructions 306 to generate control information based on the determined deviation, the control information for controlling a build operation of the additive manufacturing machine or another additive manufacturing machine in forming a 3D object.

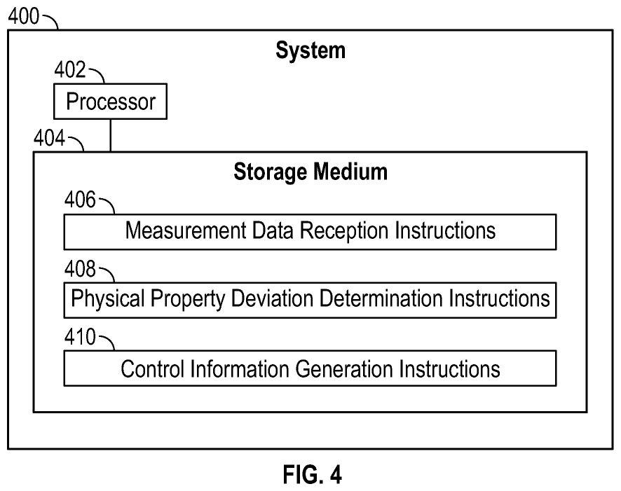

FIG. 4 is a block diagram of a system 400, which can be implemented using a computer (e.g., the computer 122 of FIG. 1) or a collection of computers. The system 400 incudes a hardware processor 402 (or multiple hardware processors). A hardware processor can include a microprocessor, a core of a multi-core microprocessor, a microcontroller, a programmable integrated circuit, a programmable gate array, a digital signal processor, or another hardware processing circuit.

The system 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions include measurement data reception instructions 406 to receive measurement data produced by non-destructive imaging of an identifiable structure within a 3D object formed using an additive manufacturing machine, the identifiable structure formed based on use of different amounts of an agent in different regions within the 3D object.

The machine-readable instructions include physical property deviation determination instructions 408 to determine, based on the measurement data, deviation of a physical property of the identifiable structure from a target physical property.

The machine-readable instructions include control information generation instructions 410 to generate control information based on the determined deviation, the control information for controlling a build operation of the additive manufacturing machine or another additive manufacturing machine.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disc (CD) or a digital video disc (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
receiving, by a system comprising a hardware processor, measurement data obtained based on a non-destructive imaging of an identifiable structure within a three-dimensional (3D) object formed using an additive manufacturing machine, the identifiable structure formed based on control of a characteristic of a build material of a first internal object portion relative to a characteristic of the build material in a second internal object portion, the first and second internal object portions being within the 3D object;
determining, by the system based on the measurement data, a deviation of a physical property of the identifiable structure from a target physical property; and
outputting, by the system, information indicating the deviation.

2. The method of claim 1, wherein the outputting comprises providing the information to a given additive manufacturing machine to cause addition, removal, or modification, based on the information, of build tasks of a build operation of the given additive manufacturing machine when forming a 3D object.

3. The method of claim 1, wherein the outputting comprises providing the information to a given additive manufacturing machine to modify, based on the information, a build operation of the given additive manufacturing machine when forming a 3D object.

4. The method of claim 3, wherein the modifying of the build operation of the additive manufacturing machine comprises modifying a value of a parameter that controls a build task by a given additive manufacturing machine.

5. The method of claim 4, wherein the parameter is selected from among a temperature parameter that controls a temperature during the build operation, a speed parameter that controls a speed of the build operation, a timing parameter that controls a timing or duration of a build task of the build operation, a build material dimension parameter that controls a dimension (e.g., thickness or another dimension) of a build material layer, and an agent parameter that controls a type or quantity of liquid agent used during the build operation.

6. The method of claim 1, wherein the determining of the deviation of the physical property of the identifiable structure comprises identifying a deformity of the identifiable structure from a target physical geometry of the identifiable structure.

7. The method of claim 6, wherein the target physical geometry of the identifiable structure comprises a shape or dimension of the identifiable structure.

8. The method of claim 1, wherein the determining of the deviation of the physical property of the identifiable structure comprises identifying a deviation of a physical coordinate of the identifiable structure from a target physical coordinate within the 3D object.

9. The method of claim 1, wherein the determining of the deviation of the physical property of the identifiable structure comprises identifying a deviation of a quality of the identifiable structure from a target quality of the identifiable structure.

10. The method of claim 1, wherein the determining of the deviation of the physical property of the identifiable structure comprises determining a deviation of an electrical property of the identifiable structure, an electromechanical property of the identifiable structure, an acoustic property of the identifiable structure, an optical property of the identifiable structure, or a chemical property of the identifiable structure.

11. The method of claim 1, comprising:
building, using the additive manufacturing machine, the identifiable structure within the 3D object based on a digital representation of the 3D object, the digital representation comprising information identifying first regions in the 3D object with a material property different from a material property of other regions in the 3D object, the first regions of the 3D object corresponding to the identifiable structure.

12. A non-transitory machine-readable storage medium comprising instructions that upon execution cause a system to:
receive measurement data of an identifiable structure within a three-dimensional (3D) object formed by a first additive manufacturing machine according to a digital representation comprising information identifying first regions in the 3D object with a material property different from a material property of other regions in the 3D object, and the information for use by the first additive manufacturing machine in controlling a first amount of an agent to be applied to a first portion of a build material that is different from a second amount of the agent to be applied to a second portion of the build material, wherein the second portion is contained within the first portion, and wherein the identifiable structure includes the second portion;
determine, based on the measurement data, a deviation of a physical property of the identifiable structure from a target physical property; and
generate control information based on the determined deviation, the control information for controlling a build operation of a given additive manufacturing machine, the given additive manufacturing machine being the first additive manufacturing machine or a different additive manufacturing machine.

13. The non-transitory machine-readable storage medium of claim 12, wherein the determining of the deviation of the physical property of the identifiable structure comprises identifying:
a deformity of the identifiable structure from a target physical geometry of the identifiable structure, or
a deviation of a physical coordinate of the identifiable structure from a target physical coordinate within the 3D object, or
a deviation of a quality of the identifiable structure from a target quality of the identifiable structure.

14. A system comprising:
a processor; and
a non-transitory storage medium storing instructions executable on the processor to:
receive measurement data produced by non-destructive imaging of an identifiable structure within a three-dimensional (3D) object formed using a first additive manufacturing machine, the identifiable structure formed based on use of different amounts of an agent in different regions within the 3D object;
determine, based on the measurement data, deviation of a physical property of the identifiable structure from a target physical property; and
generate control information based on the determined deviation, the control information for controlling a build operation of a given additive manufacturing machine, the given additive manufacturing machine being the first additive manufacturing machine or a different additive manufacturing machine.

15. The system of claim 14, wherein the agent comprises a fusing agent, a binder agent, or a contrast enhancing material.
